(19) United States
(12) Patent Application Publication
(10) Pub. No.: US 2006/0149643 A1
(43) Pub. Date: Jul. 6, 2006

(54) Automatic business date determination systems and methods

(76) Inventors: Robert Reiner, Sandhausen (DE); Patrick Karcher, Gaggenau (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/024,408

(22) Filed: Dec. 30, 2004

(51) Int. Cl. G07F 19/00; G07B 17/00

(52) U.S. Cl. 705/30

(57) ABSTRACT

Systems, methods, and computer program products consistent with the invention provide automatic determination of a date, such as the posting date, associated with a business document or business data that is entering into a data processing system, such as a financial, accounting, or ERP data processing system. For example, a system may automatically determine the posting date for an invoice entered by a user, without the user having to manually determine and type in the posting date.

### BACKGROUND

1. Field of the Invention

The present invention generally relates to data processing and computer-implemented input of data, such as a date used for business purpose. More particularly, the invention relates to systems and methods for automatically determining a posting date or transaction date for a business document.

2. Background Information

In information systems, users are often required to input dates for association with documents, plans, and data in general. In Enterprise Resource Planning (ERP) systems, purchasing systems, invoicing systems, accounting systems, and other business and planning systems, users typically enter dates associated with business documents and business data, such as an entry date, a posting date, a transaction date, or a due date, among others.

For example, when entering an invoice in a purchasing system, the user typically must enter a specific posting date or transaction date for the invoice, along with the other invoice data such as a unique invoice identification number, a due date for payment of the invoice, the name of the customer who is to receive the invoice, the customer job number to associate with the invoice, the customer's purchase order number or other customer reference number that identifies the invoice to the customer, the payback terms and other agreed terms for the invoice, a description of the goods and/or service sold, and the price, among other things. Other business documents and data, such as purchase orders and payments, typically require similar amounts of user data entry.

FIG. 1. is a representation of conventional data entry window or dialogue box for entering dates associated with a business document or data. As shown, window 100 contains a post date field 110 for the user to enter the posting date associated with a business document, a due date field 115 for the user to enter the due date associated with the business document, a description field 120 for the user to enter a description, if desired, of the business document, a post to account field 125 that contains a user selectable list of accounts, and an OK button 130 for posting the user-entered information from post date field 110, due date field 115, description field 120, and post to account field 125 into an accounting system under the account chosen by the user in post to account field 125. In the conventional system shown, the user may enter any valid date into post date field 110 by typing in the date, and when the user selects OK button 130, the system posts the data for the associated business document into the accounting ledger according to the user-entered date.

The often lengthy process of user data entry for business documents and data is time-consuming and tedious, and therefore error-prone. Errors in some entered data fields, however, are more costly than others. For example, the posting date or transaction date entered in association with an invoice or other business document or data is typically transferred to a financial or accounting system and used for processing according to the organization's accounting procedures and systems. The posting date is the operational business date for the underlying document and as such, it affects several important aspects related to an organization's accounting procedures and books. For example, the financial or accounting system that processes an invoice will typically place the invoice transaction(s) into an accounts receivable account according to the posting date. Thus, the posting date determines the accounting period that will include the invoice transactions.

An accounting period is generally a specified calendar duration used for reporting of financial information. Typically, at the end of each accounting period, an organization “closes its books” or “closes its accounts” for bookkeeping purposes and summarizes accounting data into financial statements. The process of closing the books typically locks the information used for the accounting period, preventing any further postings associated with that period, so that a stable and accurate snapshot of the business's assets and liabilities can be made for use in generating financial statements and for other business purposes.

At a minimum, an organization will close its books annually because it must file an income tax return every year. Annual financial statements, however, may not be enough to help an organization keep accurate records of its business. Also, businesses often find it helpful to close the books more frequently using shorter accounting periods, such as a month or a quarter, to assist with tasks needed during this period, such as sending out customer statements, paying suppliers, reconciling bank statements, and submitting sales tax reports to a state government, among others. So in many organizations, the books are closed and financial statements are generated, monthly or quarterly, as well as annually.

The accuracy and timeliness of the financial statements generated when the books are closed is important because the statements are used by investors, managers, and others to measure and judge the status of a business and in many cases are required by law and regulated as to their content, accuracy, and the methods used to generate the contents. And as noted, the posting date for a business document or data entered into an accounting system, such as an invoice, determines the accounting period that will include the transactions related to the document or data, and thus affects the contents of the financial statements and any tasks performed based on the data for the accounting period. For example, a user error in entering the date associated with a business document or business data, such as entering a posting date for an invoices that falls during a closed accounting period, may cause errors in the financial statements for that accounting period and subsequent periods and may cause errors in the generation of printed customer bills, among other things.

Accordingly, it is desirable to develop systems and methods for minimizing the errors caused by entering inaccurate or incorrect dates, including posting dates and transaction dates, for business documents or business data. It is also desirable to increase the efficiency of, and decrease the burden on, users that enter the date information associated with business documents and business data.

### SUMMARY OF THE INVENTION

Systems, methods, and computer program products consistent with the invention provide automatic determination of the date, such as the posting date, associated with a business document or business data that a user enters into a data processing system, such as a financial, accounting or ERP data processing system.

In accordance with one aspect of the invention, there is presented a method and computer program product for determining a date for business data, carried out by a data processing system, comprising receiving business data related to an organization; presenting a set of choices for date information; receiving a selection from the set of choices for date information; determining a date for the received business data based on the selection and accounting information related to the organization; and presenting the determined date for the received business data.

In accordance with another aspect of the invention, there is presented a method for determining a date for business data, comprising: inputting business data related to an organization into a data processing system; selecting date information from a set of choices; and prompting the data processing system to determine a date for the input business data based on the date information and accounting information related to the organization, wherein the organization uses the determined date for accounting purposes.

In accordance with another aspect of the invention, there is presented a system for determining a date for business data comprising: a receiver for receiving business data related to an organization from a user and for receiving a selection from the set of choices for date information from a user; a display for presenting a set of choices for date information to a user; a storage device for storing financial information related to the organization; a processor, connected to the receiver and storage device, for determining a date for the received business data based on the received selection and the financial information related to the organization; and a transmitter, connected to the processor, for transmitting the determined date for the received business data.

In accordance with yet another aspect of the invention, there is presented a user interface apparatus comprising: a display for displaying, to a user, a finite set of items representing a business date to associate with a set of business data; an input device for selecting a one of the a finite set of items representing a business date; and a processor for determining a date to associate with the set of business data based on the selected one of the a finite set of items and on financial information related to an organization.

Additional aspects of the invention will be set forth in part in the description which follows, and in part will be obvious from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1. is a representation of a conventional data entry window for entering dates associated with a business document or data;

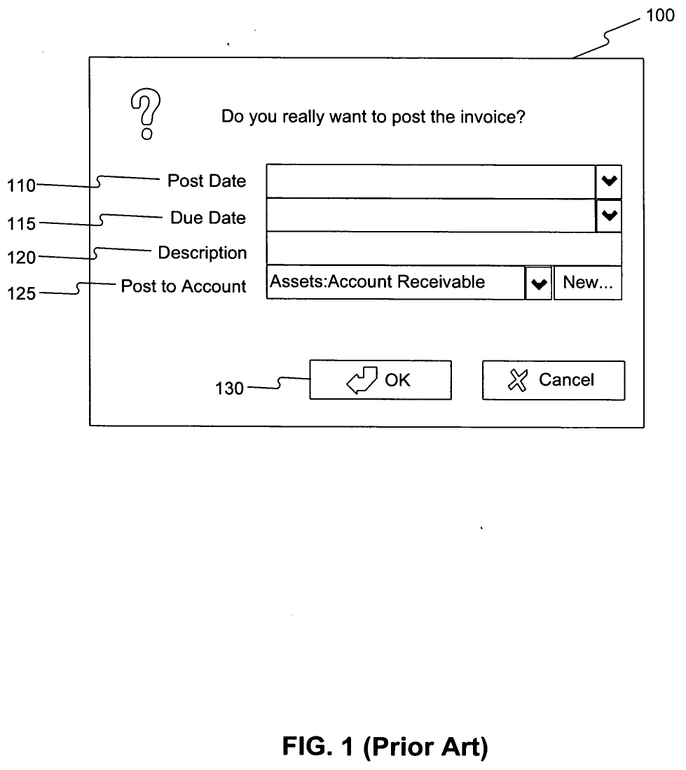

FIG. 2 is a representation of an exemplary embodiment of a user interface window for entering date information associated with a business document or data, consistent with the principles of the invention;

FIG. 3 is a representation of an exemplary embodiment of a user interface window for entering date information associated with a business document or data, consistent with the principles of the invention;

FIG. 4 is a representation of an exemplary embodiment of a user interface window for presenting a determined date that is associated with a business document or data, consistent with the principles of the invention;

FIG. 5 is a flowchart of an exemplary process for determining a date that is associated with a business document or data, consistent with the principles of the invention; and

FIG. 6 illustrates an exemplary computing system that can be used to implement embodiments of the invention.

### DETAILED DESCRIPTION

Reference will now be made in detail to exemplary implementations of the invention, examples of which are illustrated in the accompanying drawings. Wherever convenient, the same reference numbers will be used throughout the drawings to refer to the same or like parts.

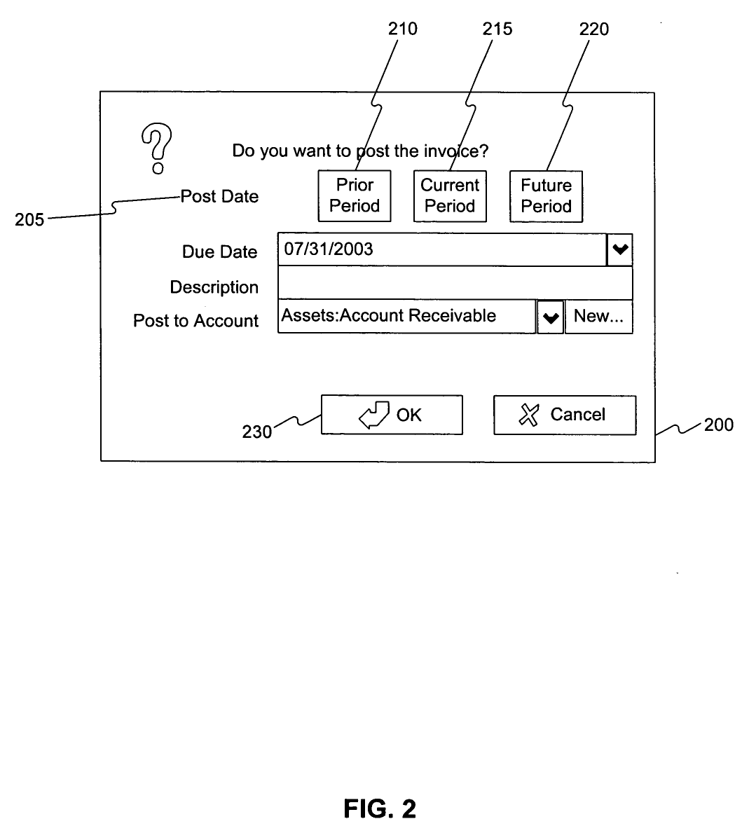

FIG. 2 is a representation of an exemplary user interface window for entering date information associated with a business document or data, consistent with the principles of the invention. As shown, window 200 contains a post date field 205 for the user to indicate a posting date associated with a business document. The post date field 205 contains three buttons, a prior period button 210, a current period button 215, and a future period button 220, which the user can select, for example by using a mouse to place a cursor on the selected button and pressing a button on the mouse. By selecting a button (210, 215 or 220), the user specifies a desired posting date to associate with a business document or data. The defined set of choices offered by the buttons 210, 215 or 220 obviates the need for the user to manually enter or define a specific posting date, and removes the possibility of typographical and other user errors. Window 200 also includes an OK button 230 for posting information corresponding to the user-selected button from the post date field 205 and the other fields in window 200 to, for example, an accounting or financial system or application.

One of ordinary skill will recognize that the three buttons, 210, 215, and 220 shown in FIG. 2 are just one example of an interface capable of presenting to a user a defined set of choices for determining a date to associate with business data, and that other user interfaces fall within the scope of the invention. For example, buttons, 210, 215, and 220 could be replaced by a menu or a list of choices without departing from the scope of the invention. One of ordinary skill will also recognize that sets of choices other than those shown also fall within the scope of the invention. For example, buttons labeled “Today's Date” and “First Day of Next Period” could have been displayed in addition to, or instead of, buttons 210, 215, and 220.

In one implementation consistent with the invention, a specific date, such as the posting date or transaction date, is calculated and recorded when a user selects a choice from the set of presented choices for determining a date. This calculation may involve several pieces of information in addition to the user's choice, such as whether an accounting period is opened or closed, the current date, when the transaction represented by the business document or data occurred, when the processing of the business document was done, and past or typical customer behavior, among others. For example, if the user selects the current period button 215, the system may calculate the posting date by checking whether the accounting period that includes today's date is open, and if so, use today's date as the posting date, but if not, use the first date of the next open accounting period as the posting date. For another example, if the user selects the prior period button 210, the system may calculate the posting date by checking whether the prior accounting period is still open, and if not, notifying the user that the document cannot be posted to the prior accounting period and requesting a different date choice from the user.

As mentioned, the date calculation may also use information regarding the customer or entity associated with the business data, such as information regarding past customer behavior, customer preferences, or customer accounting procedures and conventions, among others. For example, if the user selects the current period button 215, the system may calculate the posting date based in part on the customer's accounting periods, such as by determining the last day of the customer's current accounting period that overlaps with the user's organization's current open accounting period and using the determined day as the posting date. For another example, the system may access information on past customer behavior indicating that the customer has requested the organization not to cash payment checks until the first day of the month after a check is issued or until the end of the payment-due period and then use that information to calculate a posting date that corresponds with the customer's past behavior.

The date calculation may be performed by a data entry application, such as an invoicing application, by an accounting system or application, such as an organization's accounting system to which an invoice or other business data is posted, or by some other software application or system. In one embodiment, software modules implement the invention, and the modules may be used as a standalone application or integrated into existing software applications such as data entry applications, ERP applications, spreadsheets, invoicing applications, accounting applications, and the like.

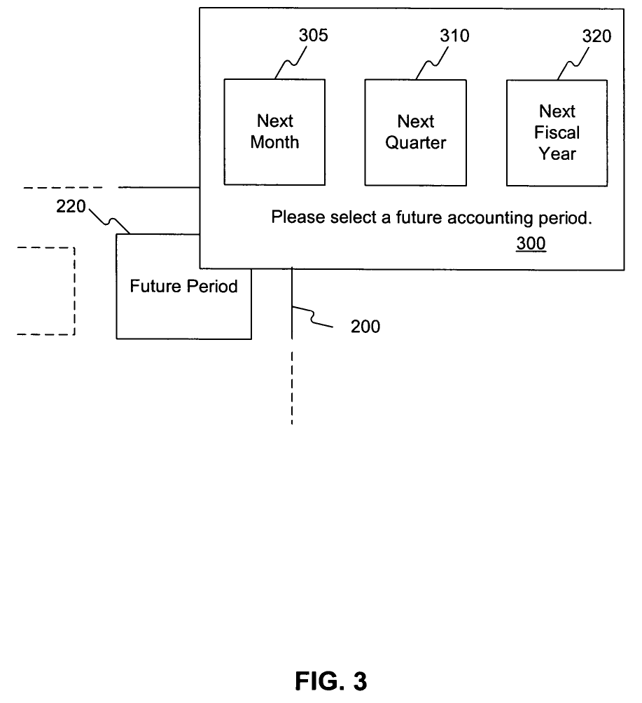

In some implementations consistent with the invention, the application determining the specific date to associate with business data or documents may require additional information from the user to calculate the date. FIG. 3 is a representation of an implementation of a user interface window for entering date information associated with a business document or data, consistent with the principles of the invention. As shown, a window 300 is displayed in response to a user selecting future period button 220 in window 200. Window 300 presents a defined set of choices related to a date to associate with business data in the form of three buttons representing a valid set of future accounting periods: next month button 305, next quarter button 310, and next fiscal year button 320.

One of ordinary skill will recognize that window 300 could contain more, fewer, or different buttons representing a valid set of date-related data choices without departing from the principles of the invention. For example, window 300 could contain only two buttons labeled “Next Month” and “Month After Next” if those were the only valid future accounting periods due, for example, to restraints imposed by law or accounting regulations. Similarly, one of ordinary skill will recognize that additional windows similar to window 300 could be displayed in response to selection of other buttons, such as prior period button 210, to gather additional information from the user for use in calculating the date to associate with a business document or business data.

As explained above, a system implementing the present invention as shown in FIG. 3 calculates a specific date, such as the posting date or transaction date for a business document, based at least in part on the user selection of next month button 305, next quarter button 310, or next fiscal year button 320. The calculation may be as simple as determining the first date of the period that corresponds to the user's selection, or it may be more complex, taking into account other information such as the current date, accounting rules and generally accepted procedures, customer preferences and behaviors, or governmental rules and regulations regarding accounting practices and corporate procedures, among other things.

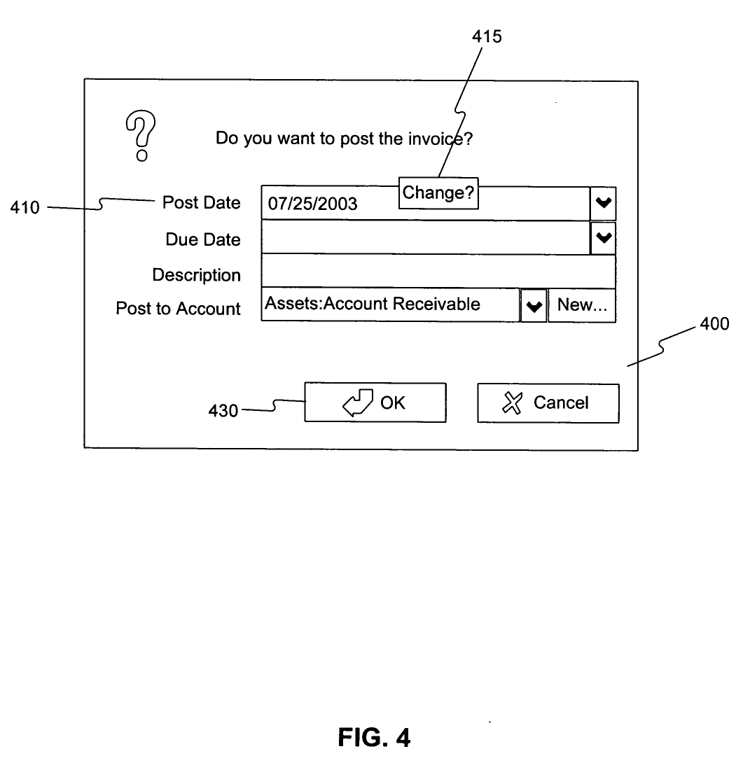

In some implementations consistent with the invention, the date calculated by the system is not presented to the user. In other implementations, the date calculated by the system is presented to the user. FIG. 4 is a representation of an implementation of a user interface window for presenting a system-determined date that is associated with a business document or data, consistent with the principles of the invention. As shown, window 400 presents the post date 410 calculated by the system in response, for example, to the user selecting current period button 215 from window 200, as shown in FIG. 2. Window 400 includes a change button 415, which the user may select to change the post date 410 calculated by the system. In one embodiment consistent with the invention, selecting change button 415 may bring up another user interface that presents a set of system-calculated valid date choices for the user to choose from. For example, if window 400 was displayed in response to the user selecting current period button 215 from window 200, then selecting change button 415 may bring up a menu of all the valid dates within the current accounting period and allow the user to select a date from the menu. In another implementation, selecting change button 415 may cause the system to display an earlier-displayed user interface, such as window 200, so that the user may begin the date specification process again.

If the user is satisfied with the date determined by the system as displayed in post date field 410, the user may select OK button 430 to associate the date with a set of business data for further processing, accounting, or other uses.

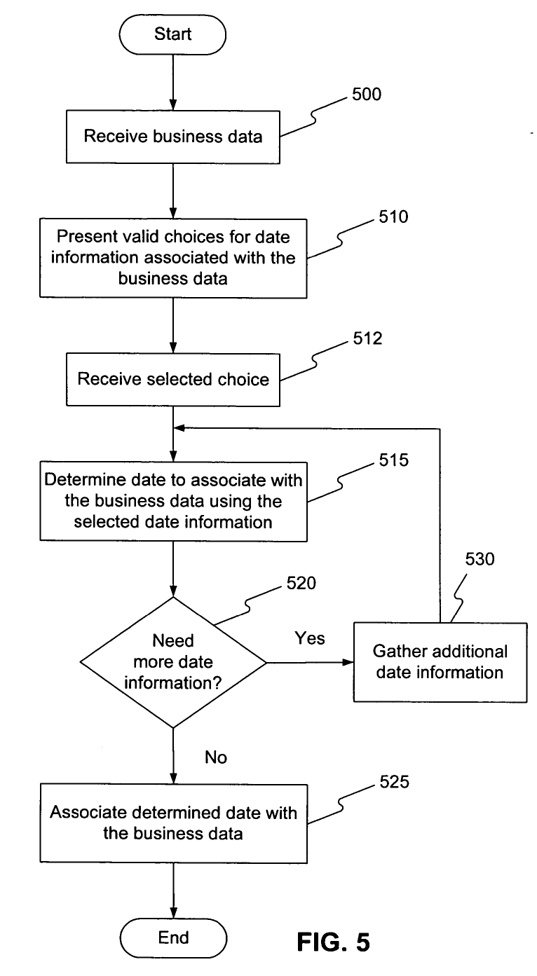

FIG. 5 is a flowchart of an exemplary process for determining a date that is associated with a business document or data, consistent with the principles of the invention. In one implementation, the process shown in FIG. 5 is carried out by a data processing system, such as an Enterprise Resource Planning (ERP) system, purchasing system, invoicing system, accounting system, or other business and planning systems that also generates a display(s) for entering date information associated with a business document or data, such as those displays shown in FIGS. 2, 3, and 4.

As shown, the process begins by receiving business data (step 500). In one implementation consistent with the invention, the system implementing the process receives business data that corresponds to a specified business document, such as an invoice, a purchase order, or a payment check, among others. For example, in the case of business data corresponding to an invoice, the business data received may include at least a customer identifier, such as a customer name or number, and an amount, such as the amount owed by the customer. The business data corresponding to an invoice could also include additional information, such as an invoice date, a reference number, a currency type, a tax amount, an account identifier, a tax code, and a profit center identifier, among other things. For another example, in the case of business data corresponding to a received customer payment, the data received may include a document date (such as the date on a check), a reference number, a bank account number, an amount, and a customer account number, or a subset of these data that is sufficient for the needs of the receiving organization's accounting systems. The business data does not necessarily have to correspond to a traditional business document, such as an invoice. In one implementation consistent with the invention, the business data may be any data that affects an organization's operations or financial statements, and that has a date associated with it that helps determine the data's effect on the organization's operations or financial statements.

Next, the process presents choices for date information associated with the business data (step 510). Presenting the user with a set of choices to select from helps to minimize errors in this date entry operation. For example, if the business data corresponds to an invoice, the system may display a set of choices for determining the posting date of the invoice, such as the choices shown for the implementation with buttons in FIG. 2. If the business data corresponds to a received customer payment, the system may display a set of choices for determining the transaction date of the payment. Other display choices may be used for different types of business data, thus making the process adaptable for use in or with different systems and applications, such as ERP systems, purchasing systems, invoicing systems, accounting systems, inventory-management systems and other automated business, business process, and planning systems.

The process then receives a selected one of the valid choices (step 512). For example, in the embodiment shown in FIG. 2, the system receives the date information choice indicated by clicking on one of the displayed buttons.

Using the selected date information, the process determines a date to associate with the business data (step 515). As described previously, determining a date to associate with the business data, such as the transaction date to associate with a purchase order, is done by calculating a specific date based on the user-selected date information and other information, such as the current date, which accounting periods are open and closed, accounting rules, generally accepted accounting procedures, laws, governmental rules and regulations, standard procedures of the organization, customer preferences, past customer behavior, etc.

Next, the process determines whether it needs more date-related information to determine the date to associate with the business data (step 520). If so (step 520, Yes), the process gathers additional date information (step 530) and again attempts to determine a date to associate with the business data (step 515). In one embodiment, gathering additional data may include presenting to a user a display with additional valid choices for date-related information, such as window 300 shown in FIG. 3.

If no further date-related information is needed (step 520, No), then the determined date is associated with business data (step 525), and the process ends. For example, in one implementation, to associate the business data with the determined date, the process passes the date and business data to a financial accounting system that enters the business transactions corresponding to the business data into the general ledger and the proper account(s) according to the determined date and updates customer transaction figures. Thus, an invoice or customer payment is posted to the proper accounts under the determined date. Once it is entered into the accounting system, the business data may be used for purposes such as generating financial statements, sending out customer statements, paying suppliers, reconciling bank statements, and submitting sales tax reports to the state government, among other things.

One of ordinary skill in the art will recognize that FIG. 5 is not the only possible implementation consistent with the present invention, as the exemplary process shown could have steps added, deleted, modified, or reordered and remain consistent with the invention. For example, steps 510 and 512 could occur before step 505. As another example, steps 520 and 530 could be deleted. One of ordinary skill will also recognize that the process shown in FIG. 5 and the interfaces shown in FIGS. 2-4 may be implemented in hardware, software, or a combination of hardware and software within the skill of the art.

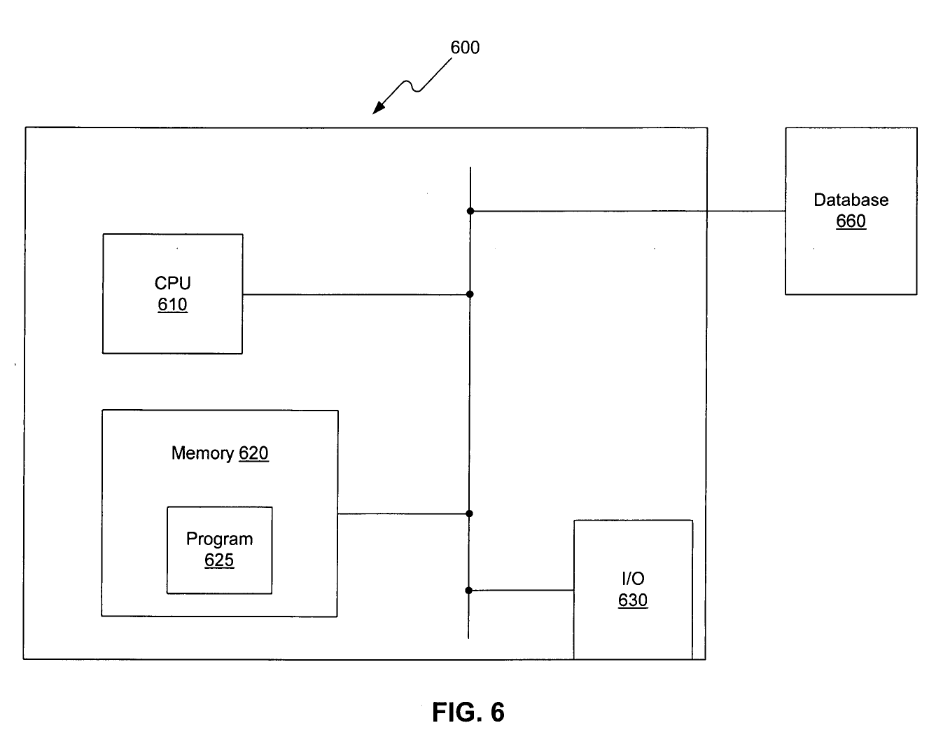

FIG. 6 illustrates an exemplary computing system 600 that can be used to implement embodiments of the invention. The components and arrangement, however, are not critical to the present invention.

System 600 includes a number of components, such as a central processing unit (CPU) 610, a memory 620, an input/output (I/O) device(s) 630, and a database 660 that can be implemented in various ways. For example, an integrated platform (such as a workstation, personal computer, laptop, etc.) may comprise CPU 610, memory 620 and I/O devices 630. In such a configuration, components 610, 620, and 630 may connect through a local bus interface and access to database 660 (implemented as a separate database system) may be facilitated through a direct communication link, a local area network (LAN), a wide area network (WAN) and/or other suitable connections. For another example, system 600 may be part of a larger ERP system, such as the SAP R/3 system.

CPU 610 may be one or more known processing devices, such as a microprocessor from the Pentium family manufactured by Intel™. Memory 620 may be one or more storage devices configured to store information used by CPU 610 to perform certain functions related to embodiments of the present invention. Memory 620 may be a magnetic, semiconductor, tape, optical, or other type of storage device. In one embodiment, memory 620 includes one or more programs 625 that, when executed by CPU 610, perform various processes consistent with the present invention. For example, memory 620 may include a purchasing program 625 that automatically determines transaction dates for purchasing documents entered by a user. Memory 620 may also include other programs that perform other functions, such as an accounting program the keeps the books of an organization and receives dated business data from the purchasing program.

Methods, systems, and articles of manufacture consistent with the present invention are not limited to programs configured to perform dedicated tasks. For example, memory 620 may be configured with a program 625 that performs several functions when executed by CPU 610. That is, memory 620 may include an enterprise resource management program for automatically determining transaction dates for business data entered by a user, for keeping the books of the organization, and for performing other supply chain management and business tasks for the organization. Alternatively, CPU 610 may execute one or more programs located remotely from system 600. For example, system 600 may access one or more remote programs that, when executed, perform functions related to embodiments of the present invention.

Memory 620 may be also be configured with an operating system (not shown) that performs several functions well known in the art when executed by CPU 610. By way of example, the operating system may be Microsoft Windows™, Unix™, Linux™, an Apple Computers operating system, Personal Digital Assistant operating system such as Microsoft CE™, or other operating system. The choice of operating system, and even to the use of an operating system, is not critical to the invention.

I/O device(s) 630 may comprise one or more input/output devices that allow data to be received and/or transmitted by system 600. For example, I/O device 630 may include one or more input devices, such as a keyboard, touch screen, mouse, and the like, that enable data to be input from a user. Further, I/O device 630 may include one or more output devices, such as a display screen, CRT monitor, LCD monitor, plasma display, printer, speaker devices, and the like, that enable data to be output or presented to a user. The configuration and number of input and/or output devices incorporated in I/O device 630 are not critical to the invention.

Database 660 may comprise one or more databases that store information and are accessed and/or managed through system 600. By way of example, database 660 may be an Oracle ™ database, a Sybase™ database, or other relational database, or database 660 may be part of an ERP system, such as the SAP R/3 system. Systems and methods of the present invention, however, are not limited to separate databases or even to the use of a database. Although some embodiments described above may relate to local and locally entered business data, those skilled in the art will appreciate that implementations of the present invention can determine dates for data from practically any source, such as other ERP systems, the internet, and other organized collections of data or memory systems.

One of ordinary skill in the art will also recognize that the implementations described and suggested above can be implemented using conventional equipment and programming techniques.

Other implementations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for determining a date for business data, carried out by a data processing system, comprising:
receiving business data related to an organization;
presenting a set of choices for date information;
receiving a selection from the set of choices for date information;
determining a date for the received business data based on the selection and accounting information related to the organization; and
presenting the determined date for the received business data.

2. The method of claim 1, wherein presenting the determined date comprises:
presenting the determined date to an accounting system; and
using the determined date as a posting date for a transaction related to the business data in the accounting system.

3. The method of claim 1, wherein presenting the determined date comprises:
using the determined date as a transaction date for a bookkeeping entry based on the business data.

4. The method of claim 1, wherein presenting the determined date comprises:
using the determined date as a transaction date for an entry in a bookkeeping ledger related to the business data.

5. The method of claim 1, wherein presenting the determined date comprises:
using the determined date as a transaction date for an entry in an account related to the business data.

6. The method of claim 1, wherein presenting the determined date comprises:
using the data to prepare a financial statement for the organization.

7. The method of claim 1, wherein accounting information related to the organization includes information regarding at least one closed accounting period for the organization.

8. The method of claim 1, wherein accounting information related to the organization includes information regarding at least one open accounting period for the organization.

9. The method of claim 1, wherein the business data corresponds to an invoice.

10. The method of claim 1, wherein the business data corresponds to a purchase order.

11. The method of claim 1, wherein the business data corresponds to a customer payment.

12. A computer program product for determining a date for business data, comprising code for causing a processor to perform operations comprising:
receiving business data related to an organization;
presenting a set of choices for date information;
receiving a selection from the set of choices for date information;
determining a date for the received business data based on the selection and accounting information related to the organization; and
presenting the determined date for the received business data.

13. The computer program product of claim 12, wherein presenting the determined date comprises:
presenting the determined date to an accounting system; and
using the determined date as a posting date for a transaction related to the business data in the accounting system.

14. The computer program product of claim 12, wherein presenting the determined date comprises:
using the determined date as a transaction date for a bookkeeping entry based on the business data.

15. The computer program product of claim 12, wherein presenting the determined date comprises:
using the determined date as a transaction date for an entry in a bookkeeping ledger related to the business data.

16. The computer program product of claim 12, wherein presenting the determined date comprises:
using the determined date as a transaction date for an entry in an account related to the business data.

17. The computer program product of claim 12, wherein presenting the determined date comprises:
using the data to prepare a financial statement for the organization.

18. The computer program product of claim 12, wherein accounting information related to the organization includes information regarding at least one closed accounting period for the organization.

19. The computer program product of claim 12, wherein accounting information related to the organization includes information regarding at least one open accounting period for the organization.

20. The computer program product of claim 12, wherein the business data corresponds to an invoice.

21. The computer program product of claim 12, wherein the business data corresponds to a purchase order.

22. The computer program product of claim 12, wherein the business data corresponds to a customer payment.

23. A method for determining a date for business data, comprising:
inputting business data related to an organization into a data processing system;
selecting date information from a set of choices; and
prompting the data processing system to determine a date for the input business data based on the date information and accounting information related to the organization, wherein the organization uses the determined date for accounting purposes.

24. The method of claim 23, wherein the accounting purpose of the determined date is use as a posting date.

25. A system for determining a date for business data comprising:
a receiver for receiving business data related to an organization from a user and for receiving a selection from the set of choices for date information from a user;
a display for presenting a set of choices for date information to a user;
a storage device for storing financial information related to the organization;
a processor, connected to the receiver and storage device, for determining a date for the received business data based on the received selection and the financial information related to the organization; and
a transmitter, connected to the processor, for transmitting the determined date for the received business data.

26. The system of claim 25, further comprising:
an accounting subsystem, communicatively connected to the transmitter, for receiving the determined date for the received business data and for associating the determined date with entries corresponding to the received business data.

27. A user interface apparatus comprising:
a display for displaying, to a user, a finite set of items representing a business date to associate with a set of business data;
an input device for selecting a one of the a finite set of items representing a business date; and
a processor for determining a date to associate with the set of business data based on the selected one of the a finite set of items and on financial information related to an organization.

28. The user interface apparatus of claim 27, wherein the finite set of items representing a business date to associate with a set of business data comprises a set of buttons.
